(19) United States
(12) Patent Application Publication
(10) Pub. No.: US 2009/0011258 A1
(43) Pub. Date: Jan. 8, 2009

(54) Method for Forming Paint Films and the Painted Objects

(75) Inventors: Masao Nakata, Yokohama (JP); Masato Tokieda, Yokohama (JP)

Correspondence Address: Mary E. Golota;Cantor Colburn LLP, 201 W. Big Beaver Road, Suite 1101, Troy, MI, 48084, US

(73) Assignee: BASF COATINGS JAPAN LIMITED, Yokohama-shi (JP)

(21) Appl. No.: 11/813,653

(22) PCT Filed: Jan. 6, 2006
(86) PCT No.: PCT/IB06/00202

§ 371 Date: Jul. 10, 2007

(30) Foreign Application Priority Data
Jan. 14, 2005 (JP) 2005-007260

(51) Int. Cl. B32B 19/04; B05D 3/02

(52) U.S. Cl. 428/450; 427/379

(57) ABSTRACT

Provided herein is a method of forming paint films using a three-coat one-bake system comprising applying a white base coat comprising titanium oxide to a polyolefin substrate comprising a primer, applying a light colored mica base coat to the white base coat wet-on-wet and then applying a clear coat to the mica base coat wet-on-wet, and then heating and hardening the polyolefin substrate comprising the while base coat, the mica base coat, and the clear, wherein the primer, white base coat and mica base coat each comprise from 0.2 to 5.0 parts by weight of a biphenylphosphate compound which can be represented by formula (1) per 100 parts by weight of resin solid fraction. Also provided herein are articles manufactured according to this method of forming paint films.

### TECHNICAL FIELD

The invention concerns a method for forming paint films in which a light colored metallic paint with which yellowing of the paint with the passage of time by sunlight (heat) is prevented is used in a system in which a white base coat paint which contains titanium oxide is painted on a paint film where a non-electrically conductive primer paint or electrically conductive primer paint has been painted on a polyolefin base material and dried, a light colored mica base coat paint is painted on wet-on-wet and then a clear paint is painted wet-on-wet on top of this, and the objects which have been painted by means of this method.

### BACKGROUND TECHNOLOGY

At the present time there is a demand for brilliant light colors on painted products which have polyolefin as the base material, such as automobile bumpers for example. In general, in the case of automobile outer panels this objective can be realized with a method in which a white-based multi-layer paint film is formed by painting on an electro-deposition paint, a mid-coat paint, a white base coat paint, a white pearl tone paint or silver pearl tone base coat paint and a clear coat paint (for example, seen Patent Citations 1 and 2).

When this method of painting is used on a polyolefin base material it is thought that there is no need for the electro-deposition paint and that, using a non-electrically conductive primer paint or an electrically conductive primer paint, a white base coat paint, a white pearl tone paint or silver pearl tone paint and a clear coat pain can then be applied sequentially, but unlike the case of a metal base material such at an outer panel of am automobile for example, in the case of a polyolefin base material there is a problem in that the paint film is subject to yellowing with the passage of time. This is thought to be due to bleeding out of the substances which are included in the base material, such as plasticizers and the like, and the phenomenon is promoted especially in those cases where heat is applied.

In general phenol-based antioxidants are widely known as antioxidants ana hydroxylamine is known as a material which is especially effective for protecting polyolefins which contain phenol-based antioxidants (for example, see Patent Citation 3). However, in the case of a light colored paint film which has a polyolefin as the base material the effect is inadequate and there is a disadvantage in that the light colored paint film yellows with the passage of time.

Furthermore, non-yellowing primer paint compositions for automobile purposes where polyolefin resins or chlorinated polyolefin resins and epoxy resins are included in the primer paint composition for use on polyolefin base materials and phosphorus-based antioxidants and one-side hindered phenol antioxidants are used conjointly are known (for example, see Patent Citation 4). However, with this method in addition to the phenol-based antioxidant which bleeds out from the material a phenol-based antioxidant is compounded in the primer paint composition as well and so the acidic products (quinone type compounds) of the phenol-based antioxidant are produced in larger quantities and there is a problem in the yellowing of the paint film due to these substances which becomes pronounced with the passage of time.

Furthermore the identity of the main volatile components from the polyolefin base material has been confirmed, and paint compositions in which metal deactivating agents are used as essential components and to which phosphite-based antioxidants and/or chlorine-free catcher agents are added as required, are known on the basis of the fact that the volatile components which cause yellowing have been specified (for example, see Patent Citation 5). However, the deactivation or metal ions by metal complex formation with the metal deactivating agent in this method has disadvantages in that there are cases where the complexes which are formed are themselves colored and cases where they promote yellowing with the passage of time after paint film formation.

### [Patent Citation 1]

### Japanese Unexamined Patent Application Laid Open H8-164358

### [Patent Citation 2]

### Japanese Unexamined Patent Application Laid Open 2002-205006

### [Patent Citation 3]

### Japanese Examined Patent Publication H7-25726

### [Patent Citation 4]

### Japanese Unexamined Patent Application Laid Open H7-118568

### [Patent Citation 5]

### Japanese Unexamined Patent Application Laid Open H10-28924

### DISCLOSURE OF THE INVENTION

### Problems to be Resolved by the Invention

The invention is to provide a method for the formation of paint films with which light colored paint films with which there is no yellowing with the passage of time due to sunlight (heat) and with which a brilliant color tone is retained can be formed, and the painted objects.

### Means of Resolving These Problems

That is to say, there is provided a method for forming a paint film in which painting is carried out with a three-coat one-bake system in which a white base paint which contains titanium oxide is painted on a paint film where a primer paint has beer painted on a polyolefin base material and dried, a light colored mica base coat paint is painted on wet-on-wet and then a clear paint is painted wet-on-wet over the top of this and then the paint films are heated and hardened in which the primer paint, white base coat paint and mica base coat paint each contain from 0.2 to 5.0 parts by mass of a biphenylphosphate compound which can be represented by formula (1) indicated below per 100 parts by mass of resin solid fraction.

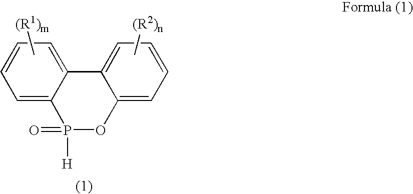

(In this formula R¹ and R² each independently represent a hydrogen atom, halogen atom, hydrocarbyl group which has from 1 to 6 carbon atoms or halogenated hydrocarbyl group which has from 1 to 6 carbon atoms, and m and n are integers of value from 0 to 4)

Furthermore, the invention provides a method for forming a paint film in which the primer paint in the abovementioned method for forming a paint film is an electrically conductive primer paint.

Furthermore, the invention provides a method for forming a paint film in which R¹ and R² of the biphenylphosphate compound represented by formula (1) in the abovementioned method for forming a paint film are all hydrogen atoms.

Furthermore, the invention provides the painted objects which have been painted by means of the abovementioned method for forming paint films.

### Effect of the Invention

Even in those cases where the base material is a polyolefin, by using the method for forming a paint film of this invention it is possible to obtain a light colored metallic paint film which is stable in respect of sunlight (heat) and yellowing with the passage of time can be prevented.

### Embodiment of the Invention

The invention is described in detail below.

Polypropylene resins and polypropylene resin based alloy material can be cited as examples of the components from which a polyolefin base material which can be used in this invention is constituted. The polypropylene resin based alloy materials are composite materials where one or more types of polymer are physically mixed with a polypropylene resin and they are known as materials where there is a synergistic effect on the overall practical performance.

No particular limitation is imposed upon the polypropylene resin based alloy materials and they include the polymer alloys comprising from 5 to 95 mass % polypropylene resin and from 95 to 5 mass % of other resin. The polymer alloys comprising from 50 to 95 mass %, and more desirably from 60 to 95 mass %, polypropylene resin and from 50 to 5 mass %, and more desirably from 40 to 5 mass % of other resin for alloying purposes can be cited polypropylene based alloy materials with which the effect of the invention is more easily demonstrated.

Polyamide resins, polyethylene terephthalate resins, polybutylene terephthalate resins, poly(vinyl chloride) resins, ethylene-propyleue-diene monomer copolymer rubbers (EPDM), ethylene-propylene copolymer rubbers (EPR), thermoplastic elastomers and the like can be cited as typical examples of tire other resins which can be used for alloying purposes. One type, or a combination of two or more types of other resin for alloying purposes can be used.

Furthermore, these other resins for alloying purposes may be partially modified to provide compatibility or dispersibility and the can also be used conjointly with compatibility improving agents.

The effect of the invention is especially pronounced in those cases where the polyolefin base material contains plasticizer. Furthermore, one type, or two or more types, of ultraviolet absorber, antioxidant, mold release agent, anti-static agent, coloring agent, flame retarder, fiber-reinforcing agent such as glass fibers for example, inorganic filler and the like can be included in the polyolefin base material to satisfy the properties required for the application.

The polyolefin base material may have various shapes, such as films, sheets, plates or solids for example.

The primer paints which are used in the invention are the paints which are in direct contact with the polyolefin base material and they fulfill a bonding role with the base material. A paint which has good adhesion with the polyolefin resin which forms the base material and also with the base coat or top coat paint and which has flexibility so that it is able to respond to the flexibility of the base material should be selected for the primer paint, and the primer paints in which resins such as polypropylene based resins and/or chlorinated polyolefin resins and the like are used can be used. The weight average molecular weight of the resin which is included in the primer paint is preferably from 1,000 to 100,000, more desirably from 5,000 to 90,000, and most desirably from 10,000 to 80,000. If the weight average molecular weight exceeds 100,000 then problems arise with poor paint operability, and if it is less than 1,000 then the cohesive strength of the resin itself is inadequate and so problems arise in that a normal paint film cannot be obtained.

The primer paint which is used in the invention may be a non-electrically conductive paint or it may be an electrically conductive paint.

An electrically conductive primer paint is a paint where an electrically conductive material is included in a primer paint. Powdered metals such as nickel and copper and white electrically conductive materials such as titanium oxide which has been coated with tin oxide or carbon can be used as the electrically conductive material which is used in an electrically conductive primer paint. The electrically conductive material particles are in contact with one another in the electrically conductive primer layer and this imparts electrical conductivity to the whole of the paint film surface.

The amount of electrically conductive material included should be selected appropriately within the range where electrical conductivity is exhibited, but generally from 0.1 to 40 parts by mass are preferred per 100 parts by mass of the resin solid fraction of the electrically conductive primer paint.

No particular limitation is imposed upon the method of applying the non-electrically conductive primer paint or electrically conductive primer paint in this invention and, for example, a non-electrically conductive primer paint or an electrically conductive primer paint can be applied by means of air sprayer painting, airless sprayer painting, low pressure spray sprayer painting (HVLP), air rotation spray painting or such like method. Neither is any limitation imposed upon the thickness of the paint film, but in the case of an electrically conductive primer paint a hardened paint film thickness of from 5 to 15 μm is preferred for realizing electrical conductivity in the paint film. In the case of a non-electrically conductive primer paint a hardened film thickness of from 5 to 15 μm is preferred from the viewpoint of the adhesion of the paint film on the base material. Most desirably the hardened paint film thickness of the primer paint is from 6 to 12 μm.

The amount of the biphenylphosphate compound which can be represented by formula (1) indicated below which is included is preferably from 0.2 to 5.0 parts by mass, more desirably from 0.5 to 4.6 parts by mass, and most desirably from 0.8 to 3.5 parts by mass, per 100 parts by mass of resin solid fraction of the primer paint.

If the amount of biphenylphosphate compound included is less than 0.2 part by mass the effect of suppressing the yellowing of the paint film is inadequate, and if it exceeds 5.0 parts by mass then the water resistance and moisture resistance of the paint film are poor.

The method for the production of the biphenylphosphate compounds represented by formula (1) which can be used in the invention is known from Japanese Unexamined Patent Application Laid Open 2004-35495. Moreover 9,10-dihydro-9-oxa-10-phosphaphenanthrene 10-oxide, for example, where both R¹ and R² are all hydrogen atoms is available as a commercial product.

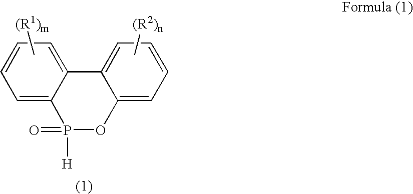

(In this formula R¹ and R² each independently represent a hydrogen atom, halogen atom, hydrocarbyl group which has from 1 to 6 carbon atoms or halogenated hydrocarbyl group which has from 1 to 6 carbon atoms, and m and n are integers of value from 0 to 4.)

The fluorine, chlorine, bromine and iodine atoms can be cited as examples of the halogen atoms in formula (1).

In formula (1) both m and n are preferably integers of value from 0 to 2, and most desirably they are 0 or 1.

The biphenylphosphate compounds which can be represented by formula (1) can be obtained easily in the way disclosed in Japanese Examined Patent Publication 49-45397, for example by subjecting an o-phenylphenol such as o-phenylphenol (2-hydroxybiphenyl)2-hydroxy-3,5,4′-trichlorobiphenyl, 2-hydroxy-3,5,4′tribromobiphenyl, 2-hydroxy-3,5-dichloro-4′-nitrobihenyl, 2-hydroxy-5-octylbiphenyl, 2-hydroxy-3-acetylbiphenyl, 4-hydroxyphenanthrene, 2-hydroxy-5,4′-dimethylbiphenyl or the like and phosphorus trichloride or phosphorus tribromide or the like to a condensation reaction by heating in the presence of a Friedel-Kraft type catalyst such as aluminum chloride or zinc chloride. Moreover, actual examples of ideal R¹ and R² groups in formula (1) include the chlorine and bromine atoms and the methyl, ethyl, isopropyl, butyl, pentyl, neopentyl, hexyl, chloromethyl, bromomethyl, dichloromethyl and trichloromethyl groups.

The white base coat paints which can be used in the invention are paints which form a white paint film, and they have a resin component, titanium oxide pigment and solvent as the main components. Furthermore, colored pigments, true pigments and paint additives can be used, as required.

A thermoset resin composition is preferred for the resin component of the white base coat paint, and combinations of one or more type of base resin such as an acrylic resin, polyester resin, alkyd resin or urethane resin, for example, which has crosslinkable functional groups such as hydroxyl groups and one or more type of crosslinking resin such as a melamine resin or a blocked polyisocyanate compound, for example, are especially desirable. The hydroxyl group value of the base resin is preferably from 30 to 200 mgKOH/g, and most desirably from 50 to 150 mgKOH/g. Furthermore, the weight average molecular weight of the base resin is preferably from 2,000 to 100,000 and most desirably from 3,000 to 30,000.

The color tone of the white base coat paint is preferably such that the L-value of the paint film measured with a color difference meter is at least 80 since it is used as a base coat for light color purposes, and for this reason the titanium oxide pigment content is preferably from 30 to 150 parts by mass, and most desirably from 50 to 90 parts by mass, per 100 parts by mass of resin solid fraction.

If the titanium oxide content is less than 30 parts by mass then the concealing power becomes unsatisfactory and it is impossible to obtain a light colored paint film of L-value at least 80, and if the titanium oxide content exceeds 150 parts by mass then the flexibility of the paint film and the adhesion with the base material are poor.

The amount of biphenylphosphate compound represented by formula (1) included is preferably from 0.2 to 5.0 parts by mass, more desirably from 0.5 to 4.6 parts by mass, and most desirably from 0.8 to 3.5 parts by mass, per 100 parts by mass of the resin solid fraction of the white base coat paint.

If the amount of biphenylphosphate compound included is less that 0.2 part by mass then the effect of suppressing the yellowing of the paint film is inadequate and if it exceeds 5.0 parts by mass then the water resistance and moisture resistance of the paint film are poor.

Furthermore ultraviolet absorbers such as benrotriazole and the oxalic acid aniline based compounds, antioxidants such as the benzophenol based compounds, leveling agents such as the silicone based materials, viscosity controlling agents such as wax and organic bentonite and hardening catalysts, for example, may be included as additives for use in paints.

No particular limitation is imposed upon the method of applying the white base coat paint and it can be applied, for example, by air sprayer painting, airless sprayer painting, air rotating spray painting of such like methods, and if an electrically conductive primer paint has been painted on the surface then the use of electro-deposition painting is preferred.

No particular limitation is imposed upon the paint film thickness of the white base coat paint, but a hardened paint film thickness of from 5 to 50 μm is preferred and a hardened paint film thickness of from 6 to 25 μm is especially desirable for concealing the underlying base and obtaining the prescribed L-value.

The resin component of the light colored mica base coat paint which is used in the invention, as in the case of the white base coat paint, is preferably a thermoset resin composition, and combinations of one or more types of base resin such as an acrylic resin, polyester resin, alkyd resin or urethane resin, for example, which have crosslinkable functional groups such as hydroxyl groups, and one or more types of melamine resin or blocked polyisocyanate compound, for example, as a crosslinking resin, are especially desirable. The hydroxyl group value of the base resin is preferably from 30 to 200 mgKOH/g, and most desirably from 50 to 150 mgKOH/g. Furthermore, the weighs average molecular weight of the base resin is preferably from 2,000 to 100,000 and most desirably from 3,000 to 30,000.

White pearl pigment and/or silver pearl pigment as an essential component and colored mica pigments, colored pigments, true pigments, dyes and the like, as required, can be used for the mica pigment which is used, in the invention.

The pigments generally known as white pearl pigment and silver pearl pigment are titanium oxide coated scale-like mica powders. The amount of titanium oxide coated scale-like mica powder compounded in the mica base coat paint is preferably from 3 to 20 parts by mass, and most desirably from 5 to 12 parts by mass, per 100 parts by mass of the resin solid fraction.

No particular limitation is imposed upon the method of applying the mica base coat paint but, as in the case of the white base coat paint, if an electrically conductive primer paint has been used then the use of electro-deposition painting is preferred. No particular limitation is imposed upon the paint film thickness of the mica base coat paint, but a hardened paint film thickness of from 5 to 50 μm is preferred and a hardened paint film thickness of from 6 to 25 μm is especially desirable.

The amount of the biphenylphosphate compound represented by formula (1) which is included is preferably from 0.2 to 5.0 parts by mass, more desirably from 0.5 to 4.6 parts by mass, and most desirably from 0.8 to 3.5 parts by mass, per 100 parts by mass of the resin solid fraction of the mica base coat paint.

If the amount of biphenylphosphate compound included is less than 0.2 part by mass then the effect of suppressing yellowing of the paint film is inadequate and if it exceeds 5.0 parts by mass then the water resistance and moisture resistance of the paint film are poor.

Furthermore ultraviolet absorbers such as benzotriazole and the oxalic acid anilide based compounds, antioxidants such as the benzophenol based compounds, leveling agents such as the silicone based materials, viscosity controlling agents such as wax and organic bentonite and hardening catalysts, for example, may be included as additives for use in paints.

The resin component of the clear paint which is used in the invention, as in the case of the white base coat paint and the mica base coat paint, is preferably a thermoset resin composition, and combination of one or more types of base resin such as an acrylic resin, polyester resin, alkyd resin or urethane resin, for example, which have crosslinkable functional groups such as hydroxyl groups, and one or more types of melamine resin or blocked polyisocyanate compound, for example, as a crosslinking resin, are especially desirable.

Furthermore ultraviolet absorbers such as benzotriazole and the oxalic acid anilide based compounds, antioxidants such as the benzophenol based compounds, leveling agents such as the silicone based materials, viscosity controlling agents such as wax, organic bentonite, NAD, microgel and the like and hardening catalysts, for example, may be included as additives for use in paints.

Moreover, solvents can be compounded, as required, in the non-electrically conductive primer paint or electrically conductive primer paint, the white base coat paint, the mica base coat paint and the clear paint. These solvents are organic solvents and they include, for example, aromatic hydrocarbon solvents such as toluene and xylene, ketone-based solvents such as acetone and methyl ethyl ketone, ester-based solvents such as ethyl acetate and butyl acetate, ether-based solvents such as butylcellosolve, and mixtures of two or more of these solvents. The amount of solvent included should be selected in such a way that the viscosity of the paint is within the range which is suitable for painting.

No particular limitation is imposed upon the method of applying the clear paint but, as in the case of the white base coat paint and the mica base coat paint, if an electrically conductive primer paint film has been used then the use of electro-deposition painting is preferred. No particular limitation is imposed upon the paint film thickness of the clear paint, but a hardened paint film thickness of from 15 to 50 μm is preferred.

The method for forming a paint film of this invention can be further improved in respect of the paint film design, finished appearance, weather resistance, resistance to chemical attack, water resistance, moisture resistance and the like by coating a non-electrically conductive primer paint or electrically conductive primer paint on the polyolefin base material and drying this paint and then applying the white base coat paint, the mica base coat paint and the clear paint sequentially wet-on-wet and then baking.

Heating to a hardening temperature of from 70 to 150° C. is preferred for hardening the paint film satisfactorily. If the hardening temperature is below 70° C. then there is a risk that the hardening will not proceed satisfactorily. If the hardening temperature exceeds 150° C. then there is a risk that deformation of the base material and a worsening of paint film properties such as yellowing of the paint film and hardening and embrittlement of the paint film will arise. The hardening time varies according to the hardening temperature, but at hardening temperatures of from 70 to 150° C. a hardening time of from 10 to 60 minutes is appropriate.

### ILLUSTRATIVE EXAMPLES

The invention is described more practical terms below by means of examples and comparative examples. However, the scope of the invention is not limited in any way by these examples.

### Example of Production 1

### <Preparation of Non-electrically Conductive Primer Paint 1>

Chlorinated polypropylene resin solution (400 parts by mass, trade name Hardren CY-9122, a chlorinated maleic anhydride modified polypropylene resin, chlorine content 22 mass %, weight average molecular weight 50,000 to 60,000, residue on heating 20 mass %, produced by one Toyo Kasei Co.), 20 parts by mass of epoxy rosin (trade name Epicoat #828, bisphenol A type liquid epoxy resin, epoxy equivalent 190, residue on heating 100 mass %, produced by the

Japan Epoxy Resin Co.), 100 parts by mass of titanium oxide, 2 parts by mass of carbon black, 3 parts by mass of 9,10-dihydro-9-oxa-10-phosphaphenanthrene 10-oxide and 300 parts by mass of xylene were mixed together in a dispersing vessel and dispersed to a particle size of not more than 10 μm in a sand mill to prepare the non-electrically conductive primer paint 1.

### Example of Production 2

### <Preparation of Electrically Conductive Primer Paint 2>

The electrically conductive primer paint 2 was prepared in the same way as in Example of Production 1 except that carbon black in Example of Production 1 was replaced by electrically conductive carbon (trade name Ketchen Black EC, produced by the Ketchen Black International Co).

### Examples of Production 3 to 8

### <Preparation of Electrically Conductive Primer Paints 3 to 8>

The electrically conductive primer paints 3 to 8 were prepared in the same way as in Example of Production 2 except that the proportions of the mixture were as shown in Table 1.

### Example of Production 9

### <Preparation of White Based Coat Paint 1>

Acrylic resin (128 parts by mass, trade name LB-9020, residue on heating 55 mass %, hydroxyl group value 56 mgKOH/g, produced by the Nippon Oil and Fat/BASF Coatings Co.), 80 parts by mass of titanium oxide, 2.6 parts by mass of 9,10-dihydro-9-oxa-10-phosphaphenanthrene 10-oxide, 20 parts by mass of xylene and 20 parts by mass of butyl acetate were mixed together in a dispersing vessel and dispersed to a particle size of not more than 10 μm in a sand mill. Then the mixture was removed from the vessel 50 parts by mass of an amino resin (trade name Yuban 122, butylated melamine resin, residue on heating 60 mass %, produced by the Mitsui Kagaku Co.) and 0.5 mass % of surface controlling agent (trade name Modaflow, acrylic copolymer, residue on heating 100 mass %, produced by the Monsanto Co.) were added and the white base coat paint 1 was prepared by stirring these together uniformly.

### Examples of Production 10 to 16

### <Preparation of White Base Coat Paints 2 to 8>

The white base coat paints 2 to 8 were prepared in the same way as the white base coat paint 1 of Example of Production 9 except that the proportions of the mixture ware as shown in Table 2.

### Example of Production 17

### <Preparation of Mica Base Coat Paint 1>

Acrylic resin (128 parts by mass, trade name LB-9020, residue on heating 55 mass %, hydroxyl group value 56 mgKOH/g, produced by the Nippon Oil and Fat/BASF Coatings Co.), 50 parts by mass of amino resin (Trade Name Yuban 122, butylated melamine resin, residue on heating 60 mass %, produced by the Mitsui Kagaku Co.), 20 parts by mass of rheology control agent (trade name LC-0988, inorganic system, residue on heating 10 mass %, produced the Nippon Oil and Fat/BASF Coatings Co.), 3.7 parts by mass of mica (titanium oxide coated scale-like mica powder (trade name Iriojin 103WS, residue on seating 100 mass %, produced by the Merck Japan Co.)), 3.0 parts by mass of 9,10-dihydro-9-oxa-10-phosphaphenanthrene 10-oxide, 0.5 part of surface controlling agent (trade name Modaflow, acrylic copolymer, residue on heating 100 mass %, produced by the Monsanto Co.), 20 parts by mass of xylene and 20 parts by mass of butyl acetate were mined and stirred uniformly for 10 minutes in a disperser to prepare a mica based paint.

### Examples of Production 18 to 24

### <Preparation of Mica Base Coat Paints 2 to 8>

The mica base coat paints 2 to 8 were prepared with the same method as in Example 17 except that the proportions of the mixture were as shown in Table 3.

TABLE 1

| | Example of Production | | | | | | | |
|---|---|---|---|---|---|---|---|---|
| | 1 | 2 | 3 | 4 | 5 | 6 | 7 | 8 |
| Primer Paint | 1 | 2 | 3 | 4 | 5 | 6 | 7 | 8 |
| Chlorinated polypropylene resin Hardren | 400 | 400 | 400 | 400 | 400 | 400 | 400 | 400 |
| CY-9132 | | | | | | | | |
| Epoxy resin Epicoat #828 | 20 | 20 | 20 | 20 | 20 | 20 | 20 | 20 |
| Titanium Oxide | 100 | 100 | 100 | 100 | 100 | 100 | 100 | 100 |
| Carbon Black | 2.0 | — | — | — | — | — | — | — |
| Electrically conductive carbon Ketchen | — | 2.0 | 2.0 | 2.0 | 2.0 | 2.0 | 2.0 | 2.0 |
| Black EC | | | | | | | | |
| Biphenylphosphate compound(Note 1) | 3.0 | 3.0 | 0.3 | 4.5 | 0.1 | 7.0 | — | — |
| Phosphorus based antioxidant(Note 3) | — | — | — | — | — | — | 1.0 | 1.0 |
| One side hindered phenol(Note 3) | — | — | — | — | — | — | 1.0 | — |
| Bensotriazole | — | — | — | — | — | — | — | 1.0 |
| Xylene | 300 | 300 | 300 | 300 | 300 | 300 | 300 | 300 |
| Total (parts by mass) | 825 | 825 | 822.3 | 826.5 | 822.1 | 829 | 824 | 824 |
| Resin solid fraction (parts by mass) | 100 | 100 | 100 | 100 | 100 | 100 | 100 | 100 |
| Proportion of biphenylphosphate | 3.0 | 3.0 | 0.3 | 4.5 | 0.1 | 7.0 | — | — |
| compound (parts by mass per 100 parts | | | | | | | | |
| by mass of resin solid fraction) | | | | | | | | |

TABLE 2

| | Example of Production | | | | | | | |
|---|---|---|---|---|---|---|---|---|
| | 9 | 10 | 11 | 12 | 13 | 14 | 15 | 16 |
| White base coat paint | 1 | 2 | 3 | 4 | 5 | 6 | 7 | 8 |
| Acrylic resin LB-9020 | 128 | 128 | 128 | 128 | 128 | 128 | 128 | 128 |
| Melamine resin Yuban 122 | 50 | 50 | 50 | 50 | 50 | 50 | 50 | 50 |
| Titanium Oxide | 80 | 80 | 80 | 80 | 80 | 80 | 80 | 80 |
| Biphenylphosphate compound(Note 1) | 3.0 | 0.3 | 4.5 | 0.1 | 7.0 | — | — | — |
| Phosphorus based antioxidant(Note 2) | — | — | — | — | — | — | 1.0 | 1.0 |
| One side hindered phenol(Note 3) | — | — | — | — | — | — | 1.0 | — |
| Benzotriazole | — | — | — | — | — | — | — | 1.0 |
| Surface controlling agent Modaflow | 0.5 | 0.5 | 0.5 | 0.5 | 0.5 | 0.5 | 0.5 | 0.5 |
| Xylene | 20 | 20 | 20 | 20 | 20 | 20 | 20 | 20 |
| Butyl acetate | 20 | 20 | 20 | 20 | 20 | 20 | 20 | 20 |
| Total (parts by mass) | 301.5 | 298.8 | 303 | 298.6 | 305.5 | 298.5 | 300.5 | 300.5 |
| Resin solid fraction (parts by mass) | 100.4 | 100.4 | 100.4 | 100.4 | 100.4 | 100.4 | 100.4 | 100.4 |
| Proportion of biphenylphosphate compound | 3.0 | 0.3 | 4.5 | 0.1 | 7.0 | — | — | — |
| (parts by mass per 100 parts by mass of | | | | | | | | |
| resin solid fraction) | | | | | | | | |

TABLE 3

| | Example of Production | | | | | | | |
|---|---|---|---|---|---|---|---|---|
| | 17 | 18 | 19 | 20 | 21 | 22 | 23 | 24 |
| Mica base coat paint | 1 | 2 | 3 | 4 | 5 | 6 | 7 | 8 |
| Acrylic resin LB-9020 | 128 | 128 | 128 | 128 | 128 | 128 | 128 | 128 |
| Melamine resin Yuban 122 | 50 | 50 | 50 | 50 | 50 | 50 | 50 | 50 |
| Titanium Oxide coated scale-like mica | 3.7 | 3.7 | 3.7 | 3.7 | 3.7 | 3.7 | 3.7 | 3.7 |
| Iriojin 103WS | | | | | | | | |
| Biphenylphosphate compound (Note 1) | 3.0 | 0.3 | 4.5 | 0.1 | 7.0 | — | — | — |
| Phosphorus based antioxidant (Note 2) | — | — | — | — | — | — | 1.0 | 1.0 |
| One side hindered phenol (Note 3) | — | — | — | — | — | — | 1.0 | — |
| Benzotriazole | — | — | — | — | — | — | — | 1.0 |
| Rheology control agent LC-0988 | 20 | 20 | 20 | 20 | 20 | 20 | 20 | 20 |
| Surface controlling agent Modaflow | 0.5 | 0.5 | 0.5 | 0.5 | 0.5 | 0.5 | 0.5 | 0.5 |
| Xylene | 20 | 20 | 20 | 20 | 20 | 20 | 20 | 20 |
| Butyl acetate | 20 | 20 | 20 | 20 | 20 | 20 | 20 | 20 |
| Total (parts by mass) | 245.2 | 242.5 | 246.7 | 242.3 | 249.2 | 242.2 | 244.2 | 244.2 |
| Resin solid fraction (parts by mass) | 100.4 | 100.4 | 100.4 | 100.4 | 100.4 | 100.4 | 100.4 | 100.4 |
| Proportion of biphenylphosphate compound | 3.0 | 0.3 | 4.5 | 0.1 | 7.0 | — | — | — |
| (parts by mass per 100 parts by mass of | | | | | | | | |
| resin solid fraction) | | | | | | | | |

Notes for Tables 1 to 3
Note 1)
Biphenylphosphate Compound: HCA (9,10-Dihydro-9-oxa-10-phosphaphenanthrene 10-oxide, produced by the Sanko Kagaku Co.)
Note 2)
Phosphorus Based Antioxidant: Adekastab 2112 (Tris(2,4-di-t-butylphenyl)phosphite, produced by the Asahi Denka Co.)
Note 3)
One Side Hindered Phenol: Sumilizer GA-80 (3,9-Bis[1,1-dimethyl-2-[β-(3-t-butyl-4-hydroxy-5-methylphenyl)propionyloxy]ethyl]-2,4,8,10-tetraoxaspiro[5,5]-undecane, produced by the Sumitomo Kagaku Co.)

### Example 1

The surface of a commercial black polypropylene sheet (which contained plasticizer (length 70 mm×width 150 mm×thickness 3 mm) was wiped with isopropyl alcohol and any contamination or dust attached to the object for painting was removed. Then the non-electrically conductive primer paint of Example of Production 1 of which the Ford Cup #4 viscosity at 20° C. had been adjusted with xylene to 11 seconds was applied with an air sprayer in such a way as to provide a dry paint film thickness of from 6 to 8 μm. After being left to stand for 2 minutes at room temperature for setting, the white base coat paint 1 of Example of Production 9 of which Ford Cup #4 viscosity at 20° C. had been adjusted to 15 seconds with xylene was applied with an air sprayer in such a way as to provide a dry paint film thickness of 15 μm. Then, the mica base coat paint 1 of Example of Production 17 (5.5 parts by mass of titanium oxide coated scale-like mica powder compounded per 100 parts by mass of resin solid fraction) was adjusted to a Ford Cup #4 viscosity at 20° C. of 15 seconds and applied wet-on-wet with an air sprayer in such a way as to provide a dry paint film thickness of 15 μm, and then an acrylic resin based clear paint (trade name Primack No. 5900 Clear, a clear paint, produced by the Nippon Oil and Fat/BASF Coatings Co.) was applied wet-on-wet with non-electrostatic painting in such a way as to provide a dry film thickness of 30 μm and then it was held at a temperature of 120° C. for 20 minutes in a drier and a painted test sheet was obtained.

### Example 2

The surface of a commercial black polypropylene sheet (which contained plasticizer (length 70 mm×width 150 mm×thickness 3 mm) was wiped with isopropyl alcohol and any contamination or dust attached to the object for painting was removed. Then the electrically conductive primer paint or Example of Production 2 of which the Ford Cup #4 viscosity at 20° C. had been adjusted to 11 seconds with xylene was applied with an air sprayer in such a way as to provide a dry paint film thickness of from 6 to 8 μm. After being left to stand for 2 minutes at room temperature for setting, the white base coat paint 1 of Example of Production 7 of which Ford Cup #4 viscosity at 20° C. had been adjusted to 15 seconds with xylene was applied by means of electro-deposition painting in such a way as to provide a dry paint film thickness of 15 μm. Then, the mica base coat paint 1 at Example of Product 1 on 17 was adjusted to a Ford Cup #4 viscosity at 20° C. of 15 seconds and applied wet-on-wet by means of electro-deposition painting in such a way as to provide a dry paint film thickness of 15 μm, and then an acrylic resin based clear paint (trade name Primack No. 5900 Clear, a clear paint, produced, by the Nippon Oil and Fat/BASF Coatings Co.) was applied wet-on-wet by means of electrostatic painting in such a way as to provide a dry film thickness of 30 μm and then it was held at a temperature of 120° C. for 20 minutes in a drier and a painted test sheet was obtained.

### Examples 3 to 10

Test sheets were produced in the same way as in Example 2 except that the paint combinations were changed as shown in Table 4 and tests were carried out.

### Comparative Examples 1 to 5

Test sheets were produced in the same way as in Example 2 except that the paint combinations were changed as shown in Table 5 and tests were carried out.

Paint film performance tests were carried out using these test sheets. The results are shown in Table 4.

TABLE 4

| | | Example | | | | |
|---|---|---|---|---|---|---|
| | | 1 | 2 | 3 | 4 | 5 |
| Primer Paint | | 1 | 2 | 3 | 4 | 5 |
| Proportion of biphenylphosphate | | 3.0 | 3.0 | 0.3 | 4.5 | 0.3 |
| compound (parts by mass per | | | | | | |
| 100 parts by mass resin | | | | | | |
| solid fraction) | | | | | | |
| White Base Coat Paint | | 1 | 1 | 2 | 3 | 1 |
| Proportion of biphenylphosphate | | 3.0 | 3.0 | 0.3 | 4.5 | 3.0 |
| compound (parts by mass per | | | | | | |
| 100 parts by mass resin | | | | | | |
| solid fraction) | | | | | | |
| Mica Base Coat Paint | | 1 | 1 | 2 | 3 | 2 |
| Proportion of biphenylphosphate | | 3.0 | 3.0 | 0.3 | 4.5 | 0.4 |
| compound (parts by mass per | | | | | | |
| 100 parts by mass resin | | | | | | |
| solid fraction) | | | | | | |
| Adhesion of the Paint Film | | ◯ | ◯ | ◯ | ◯ | ◯ |
| L-Value of the Multi-layer Paint Film | | 85.3 | 85.4 | 85.1 | 86.0 | 85.2 |
| Resistance to thermal yellowing (Δb) | | 1.0 | 1.0 | 1.6 | 0.6 | 1.2 |
| Water Resistance | Adhesion | ◯ | ◯ | ◯ | ◯ | ◯ |
| | Appearance | ◯ | ◯ | ◯ | Δ◯ | ◯ |
| Moisture Resistance | Adhesion | ◯ | ◯ | ◯ | ◯ | ◯ |
| | Appearance | ◯ | ◯ | ◯ | Δ◯ | ◯ |

TABLE 5

| | | Comparative Example | | | | |
|---|---|---|---|---|---|---|
| | | 1 | 2 | 3 | 4 | 5 |
| Primer Paint | | 5 | 6 | 2 | 7 | 8 |
| Proportion of biphenylphosphate | | 0.1 | 7.0 | 3.0 | — | — |
| compound (parts by mass per 100 | | | | | | |
| parts bymass resin solid fraction) | | | | | | |
| White Base Coat Paint | | 4 | 5 | 6 | 7 | 8 |
| Proportion of biphenylphosphate | | 0.1 | 7.0 | — | — | — |
| compound (parts by mass per 100 | | | | | | |
| parts by mass resin solid fraction) | | | | | | |
| Mica Base Coat Paint | | 4 | 5 | 6 | 7 | 8 |
| Proportion of biphenylphosphate | | 0.1 | 7.0 | — | — | — |
| compound (parts by mass per 100 | | | | | | |
| parts by mass resin solid fraction) | | | | | | |
| Adhesion of the Paint Film | | ◯ | ◯ | ◯ | ◯ | ◯ |
| L-Value of the Multi-layer Paint Film | | 85.3 | 85.3 | 85.2 | 85.1 | 85.2 |
| Resistance to thermal yellowing (Δb) | | 3.5 | 0.4 | 3.2 | 4.1 | 2.8 |
| Water Resistance | Adhesion | ◯ | Δ | ◯ | ◯ | ◯ |
| | Appearance | ◯ | Δ | ◯ | ◯ | ◯ |
| Moisture Resistance | Adhesion | ◯ | X | ◯ | ◯ | ◯ |
| | Appearance | ◯ | X | ◯ | ◯ | ◯ |

### Adhesion of the Paint Film

Eleven longitudinal and transverse cuts were made with a cutter knife on the test sheet in such a way as to form 100 squares with a spacing of 2 mm and the state of peeling on applying cellophane tape was evaluated. The results of the evaluation are indicated in the following way:

∘: No peeling away of the paint film. (In terms of the squares, 100/100)
Δ: Some peeling of the paint film. (In terms of the squares, 85 to 99/100)
X: Almost all of the paint film peeled away. (In terms of the squares, 0 to 84/100)

### L-Value

The L-value of the test sheet was measured with a color difference meter CR-200 (produced by the Minolta Co.) A larger numerical value indicates a brighter whiteness.

### Resistance to Thermal Yellowing

The test sheet was left to stand for 90 days in a drier which had been set to a temperature of 80°C. and then taken out and, after 1 hour, the b-value was measured using a color difference meter CR-200 (produced by the Minolta Co.). The assessment of yellowing (Δb) was good if the value was not more than 2, and provided that the numerical value is small, a smaller value is preferred.

The yellowing (Δb) was calculated using the following equation:

Δb=(b-Value After Heat Resistance Test)−(b-Value Before Heat Resistance Test)

### Water Resistance

De-ionized water was introduced into a constant temperature water bath (set temperature 35°) which was fitted with stirring apparatus and the test sheet was immersed in the water and left to stand for 240 hours. The water was then removed from the surface with a paper towel and, after being left to stand for 1 hour at room temperature, the appearance of the paint film and the adhesion of the paint film were evaluated. The results of the evaluations are shown in the way indicated below in the case of the appearance of the paint film and in the same way as before in the case of the adhesion of the paint film.

∘: No abnormality.
∘Δ: Some loss of gloss but recovered completely on being left to stand for 12 hours.
Δ: Some loss of gloss but recovered completely on being left to stand for 24 hours.
X: Loss of gloss which did not recover even after being left to stand for 24 hours.

### Moisture Resistance

A 240 hour moisture resistance test was carried out using moisture resistance measuring apparatus as laid down in JIS K5600-7-2. The test sheet was taken out and the water on the surface was removed with a paper towel and, after being left to stand for 1 hour at room temperature, the appearance of the paint film and the adhesion of the paint film were evaluated. The results of the evaluations are shown in the way indicated below in the case of the appearance of the paint film and in the same way as before in the case of the adhesion of the paint film.

∘: No abnormality.
∘Δ: Some loss of gloss but recovered completely on being left to stand for 12 hours.
∘Δ: Some loss of gloss but recovered completely on being left to stand for 24 hours.
x: Loss of gloss which did not recover even after being left to stand for 24 hours.

1. A method of forming a paint film using a three-coat one-bake system, comprising
applying a white base coat comprising titanium oxide to a substrate, wherein the substrate comprises a primer applied to a polyolefin base material and dried,
applying a light colored mica base coat to the white base coat wet-on-wet,
applying a clear coat to the mica base coat wet-on-wet, and
heating and hardening the white base coat, the mica base coat, and the clear coat,
wherein the primer, white base coat and mica base coat each comprise from 0.2 to 5.0 parts by weight, based on 100 parts by weight of resin solid fraction, of a biphenylphosphate compound according to formula (1) indicated below: 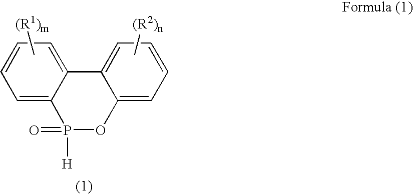
wherein R¹ and R² are each independently a hydrogen atom, halogen atom, hydrocarbyl group having from 1 to 6 carbon atoms or halogenated hydrocarbyl group having from 1 to 6 carbon atoms, and m and n are integers of value from 0 to 4.

2. The method of claim 1 wherein the primer is an electrically conductive primer.

3. The method of claim 1 wherein R¹ and R² are all hydrogen atoms.

4. An article comprising a paint film made by the method of claim 1.

5. The method of claim 1, wherein the polyolefin is selected from the group consisting of a polypropylene resin, a polypropylene resin alloy, and a combination thereof.

6. The method of claim 1, wherein the primer comprises a resin comprising polypropylene, chlorinated polyolefin, or a combination thereof.

7. The method of claim 1, wherein the white base coat, the mica base coat, the clear coat, or a combination thereof comprise a thermoset resin.

8. The method of claim 7, wherein the thermoset resin is selected from the group consisting of an acrylic resin, a polyester resin, an alkyd resin, a urethane resin, and a combination thereof.

9. The method of claim 7, wherein the thermoset resin comprises a crosslinkable functional group.

10. The method of claim 9, wherein the crosslinkable functional group has a hydroxyl group present in the thermoset resin in an amount of from 30 to 200 mgKOH/g.

11. The method of claim 7, wherein the white base coat, the mica base coat, and the clear coat further comprise a crosslinking resin.

12. The method of claim 11, wherein the crosslinking resin is selected from the group consisting of a melamine resin, a blocked polyisocyanate compound, and a combination thereof.

13. The method of claim 1, wherein the white base coat comprises from 30 to 150 parts by weight titanium oxide, based on the total weight of the white base coat resin solid fraction.

14. The method of claim 1, wherein the mica base coat comprises a white pearl pigment, a silver pearl pigment, or a combination thereof.

15. The method of claim 1, wherein the primer comprises 0.2 to 5.0 parts by weight of the biphenylphosphate compound per 100 parts by weight of resin solid fraction of the primer.

16. The method of claim 1, wherein the white base coat comprises 0.2 to 5.0 parts by weight of the biphenylphosphate compound per 100 parts by weight or resin solid fraction of the white base coat.

17. The method of claim 1, wherein the mica base coat comprises 0.2 to 5.0 parts by weight of the biphenylphosphate compound per 100 parts by weight of resin solid fraction of the mica base coat.

18. The method of claim 1, wherein R¹ and R² are independently selected from the group consisting of a chlorine atom, a bromine atom, a methyl group, an ethyl group, an isopropyl group, a butyl group, a pentyl group, a neopentyl group, a hexyl group, a chloromethyl group, a bromomethyl group, a dichloromethyl group, and a trichloromethyl group.
